(19) United States
(12) Patent Application Publication
(10) Pub. No.: US 2006/0263752 A1
(43) Pub. Date: Nov. 23, 2006

(54) Teaching method for the rapid acquisition of attractive, effective, articulate spoken english skills

(76) Inventor: Michele Moore, Atlanta, GA (US)

Correspondence Address: MICHELE MOORE, 2359 VIRGINIA PLACE NE, ATLANTA, GA, 30305, US

(21) Appl. No.: 11/410,645

(22) Filed: Apr. 25, 2006

Related U.S. Application Data
(60) Provisional application No. 60/674,404, filed on Apr. 25, 2005.

(51) Int. Cl. G09B 19/04

(52) U.S. Cl. 434/185

(57) ABSTRACT

The invention is a method for teaching attractive, articulate spoken English quickly and effectively. The method focuses on speaker well-being, balance, relaxation and breathing in additional to appealing vocal projection. Skills are summarized by simple, catchy coaching credos making them easy to recall and apply. Individual skills are combined into summary coaching credos reinforcing the desired delivery method as a whole. The invention can be customized for industries such as accounting, healthcare or elementary education and can be adapted for languages other than English. The method is especially effective for teaching attractive, articulate speaking skills to workgroups who can continue to coach and help each other improve their speaking skills over time. The method focuses on reinforcing comprehension and retention by teaching participants to coach each other to adopt and improve skills they themselves are also trying to acquire. The method is fueled with fun, positive feedback and immediate success.

### CROSS REFERENCED TO RELATED APPLICATIONS

This application claims the benefits of PPA Ser. No. 60/674,404 filed Apr. 25, 2005 by the present inventor. The following patents support this application:

| | | |
|---|---|---|
| 6736641 | May 2004 | Quiroz |
| 4247995 | February 1981 | Heinberg |
| 4115932 | September 1978 | Charlesworth |
| 3823491 | July 1974 | Lehmann |
| 3798797 | March 1974 | Mandel |
| 3715812 | February 1973 | Novak |

### FEDERALLY SPONSORED RESEARCH

Not Applicable

### SEQUENCE LISTING OR PROGRAM

Not Applicable

### BACKGROUND OF THE INVENTION—FIELD OF THE INVENTION

This invention generally relates to teaching spoken English skills, specifically to developing attractive, articulate spoken English skills quickly and effectively.

### BACKGROUND OF THE INVENTION—PRIOR ART

Traditional methods for teaching attractive English vocal production skills are very tedious, complicated, time consuming and confusing. They usually require the use of a specialized voice coach or instructor to ensure that appropriate exercises are selected and correctly executed. They often involve repeating simple words, phrases and phonemes over and over again with the intent of creating correct English sounds.

Students often have trouble transferring their practice into practical use in spoken English. They often retain the rhythm, beat and accents of their native tongue or their previous speech.

Traditional methods emphasize getting it right and creating correct English sounds rather than producing attractive, appealing, effective English sounds and sentences.

These traditional methods draw on centuries old speech exercises and techniques. Specific speech exercises may be selected to address particular vocal difficulties, deficiencies or pathologies. They focus on correcting inadequacies and what is spoken incorrectly rather than building on and strengthening what the speaker already knows and does well.

Traditional methods often utilize repetitive, redundant exercises and dreary drills to strengthen and correct pronunciation, improve diction and enhance vocal production.

Because of the lengthy, complicated, expensive coaching process, such traditional methods are not appealing or appropriate for the majority people who already speak English well but who want to improve the sound of their voices for business and personal reasons.

With the advent of modern technology (e.g. audio CDs, video tapes, DVDs, computer programs and the like), some voice instructors have made these traditional teaching methods available through modern media technologies. The traditional exercises are still tedious, time consuming, frustrating and confusing. These media programs are often used to attract students to the instructors' individualized, personal voice coaching programs.

Instructors of these traditional methods fail to recognize that speaking is a social skill and not purely a physical or intellectual skill.

Most adults have no idea how they really sound to other people. They are often shocked and dismayed when they hear their own voices replayed on voice mail or on recordings. Stress and tension often negatively affect and degrade the tone of their voices.

Many people sound stressed, strident or shrill when they are under pressure or when they speak to important people or to groups of people. Traditional instructional methods do not address these problems quickly, easily or effectively.

Offering people an opportunity to quickly and easily learn how to speak in a clear, confident, compelling tone of voice irrespective of their circumstances greatly contributes to their success, self esteem and well-being. It opens doors to improved communications and enhanced understanding and well-being between individuals from all walks of life.

### BACKGROUND OF INVENTION—OBJECTS AND ADVANTAGES

Accordingly, several objects and advantages of the invention include:
1) Emphasis is placed on producing attractive, articulate speech rather than just speaking correctly. When speech sounds pleasant and articulate listeners want to pay attention.
2) Skills are summarized in just a few clear, simple statements called coaching credos that are easy to recall and apply to all speaking circumstances. Students are not over whelmed by a multitude of new rules and directives.
3) The invention's coaching credos are intentionally linked to concepts participants may already understand and sense intuitively which minimizes the amount of new learning.
4) Students select their own materials to practice with that are of interest to them.
5) The teaching method emphasizes sounding good because speakers honestly feel good. Participants are taught how to consistently place themselves in an optimal zone of personal well-being that supports superior speech and peak performance.
6) The invention's teaching method describes the roles habits play both in speech and in general behavior and details methods to easily and effectively change all types of habits.
7) The invention's teaching method is intentionally fueled with fun, positive feedback and lots of immediate successes.
8) Sources of tension that strangle speech are identified and techniques to overcome the effects of stress and tension are provided by the invention's teaching method.
9) Posture, breathing, and relaxed well-being techniques are taught as tools-participants can use to sound good and feel good whenever they wish.

Further objects and advantages of this invention will become apparent from a consideration of the drawings and ensuing description.

### SUMMARY

In accordance with the invention, the teaching method allows participants to rapidly and effectively acquire attractive, articulate spoken English skills. The invention emphasizes sounding good and producing pleasant tones rather than just making correct English sounds. Once speech sounds attractive, it becomes correct.

### DRAWINGS

FIG. 1 Body Balance Side View—shows optimal body balance and bearing

FIG. 2 Body Balance Visualization Side View—shows evolution to optimal visualization

FIG. 3 Lungs Relaxed/Resting Exhale Position—shows human chest in relaxed, exhale

FIG. 4 Lungs Inhale—shows human chest in inhale position

FIG. 5 Perfect Posture—Optimal Posture Visualization—shows optimal body bearing

### DETAILED DESCRIPTION—PREFERRED EMBODIMENT

A method of teaching where participants learn to:
1. Listen to the rhythm and beat of their speech as they speak to gauge and alter the flow of their spoken delivery and to hear what listeners hear.
2. Speak with a beat, punching each word and syllable slightly, speaking with a slight staccato to add power, polish and definition to their spoken word diction.
3. Extend spoken vowel sounds, to power vowels by lengthening vowel sounds in key words to add emotion and emphasis to speech while enhancing the rhythm, flow, beat and melody of their vocal delivery.
4. Insert slight slivers of silence between words and syllables, especially between similar sounding syllables to significantly sharpen speech and diction.
5. Punctuate with pauses, substituting intentional pauses for irritating filler words such as errrrs, ahhhs and uhmms that detract from powerful, polished speech. Pauses are used to phrase speech and provide time for breathing.
6. Speak in polished phrasing of eight to ten beats or syllables per phrase, separated by brief pauses to breathe which aids listener comprehension and helps to maintain an easy flow of vocal delivery.
7. Practice with poetry or by speaking a favorite song to reinforce their new vocal skills. Songs and poems have natural beats and phrasing.
8. Get going with a giggle to use dual diaphragm drive to engage lower abdominal pelvic muscles to propel powerful vocal projection.
9. Emphasize or kick consonant sounds, adding add energy and emphasis to consonant sounds adds significant clarity to speech.
10. Yodel yawn to relax tight, tense throat and neck muscles, eliminating throat tension and strangled speech.
11. Target their vocal tone with their voice and body bearing to connect with their best vocal and most appropriate vocal presentation skills.
12. Sing slightly as they speak which summarizes many of these separate skills. When people sing they naturally listen to the sound of their voice, they speak with a beat, extend vowel sounds, punctuate with pauses, breathe and phrase naturally.
13. Practice vocal skills by reading to children summarizes and reinforces many of the separate skills and encourages participants to add feelings of fun and fantasy to their vocal delivery.

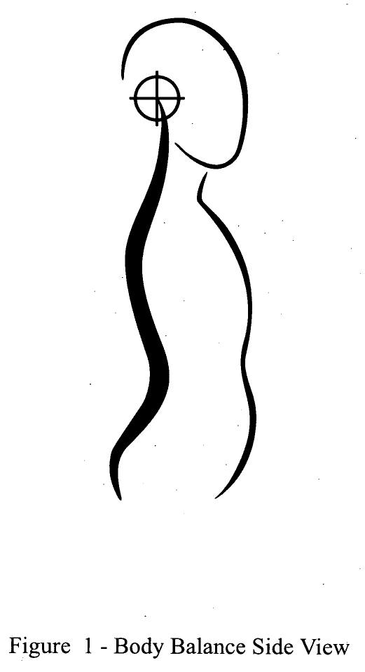

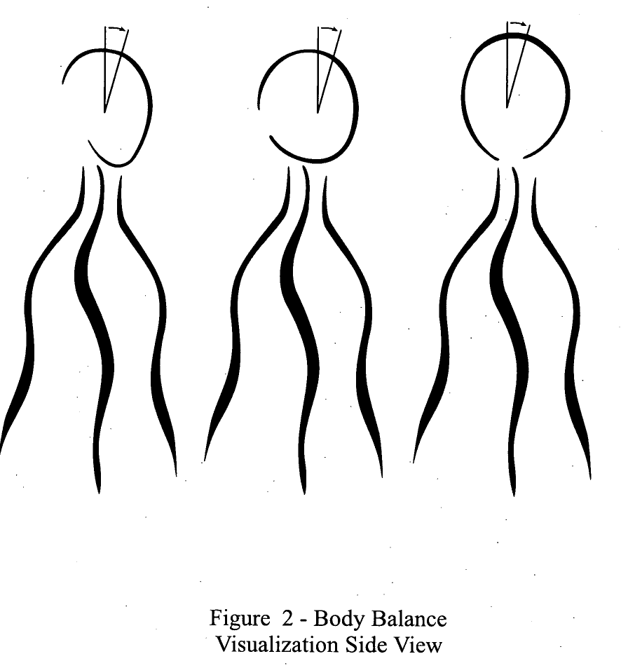

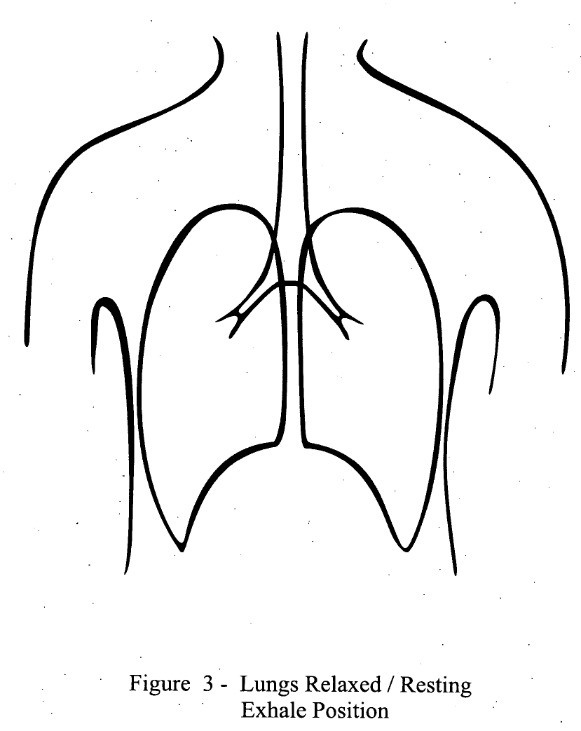

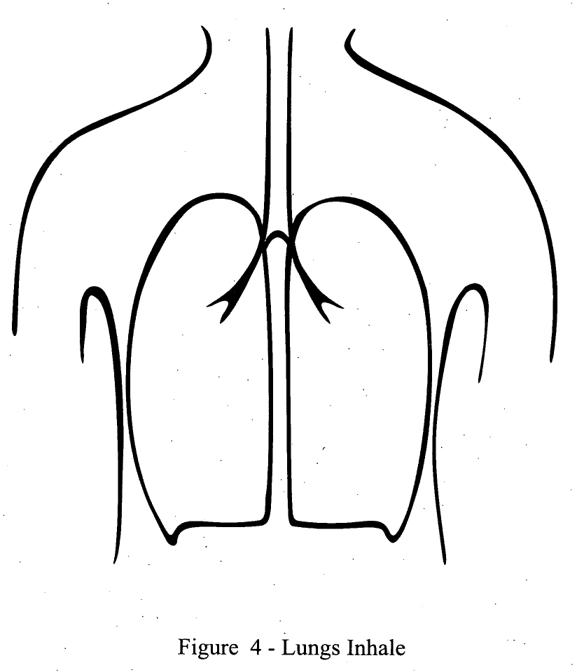

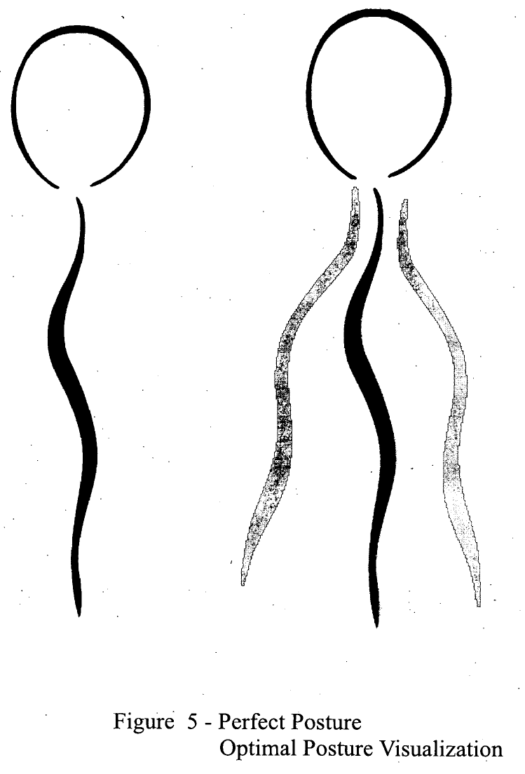

The invention's teaching method includes posture, mental and physical skill exercises and illustrations which support and enhance vocal delivery skills:
14. Optimal power-posture, relaxed well-being requires a balanced body and deep breathing as depicted in Drawing FIGS. 1, 2 and 5.
15. Breaking wave breathing techniques teach deep abdominal breathing as depicted in Drawing FIGS. 3 and 4.
16. Beam, balance and breathe to anchor in optimal posture and body bearing while consciously connecting with powerful, successful positive thoughts and feelings.

The invention's teaching method includes exercises to emphasize and demonstrate the relationship between body balance, deep, relaxed abdominal breathing and enhanced mental and physical well-being.
17. Breathing becomes a barometer of body balance demonstrations and exercises.

The invention's teaching method provides an organized means of specifically experiencing sources of physical and mental tension, and teaches methods to over come them:
18. Clenched fist exercise demonstrating how tension is transmitted through out the body, tires muscles, inhibits breathing and makes people feel and anxious.
19. Clench and tense to come to attention demonstrates how people naturally tend to clench and tense their bodies to raise their level of attention and encourage mental alertness. Tension held in the body soon becomes very tiring, it inhibits deep, relaxed breathing, strangles speech and raises stress levels.
20. Tight tummy exercises demonstrate how a primary symptom of stress, tension held in the lower abdomen limits breathing, speech and relaxed, well-being.
21. Exercises demonstrating how posture affects and prompts the feelings and the mental perspectives people adopt.
22. Exercises demonstrating how slumping is stressing and slanted stance is stressing.
23. Exercises contrast fearfully pulling energy inwards, clenching and tensing in defense, versus radiating relaxed energy confidently outwards to demonstrate how optimal posture and consciously radiating assurance outwards enhances confidence and well-being.
24. Exercise to demonstrate how people naturally tend to assume the emotions they project.

The method also includes exercises and explanations teaching participants how to consistently connect with their zone of optimal effectiveness and well-being.
25. Best self exercises and explanations show participants how to connect with their optimal physical energy state and their best self ideal.
26. Energy dancing exercises illustrate how to energize without clenching and tensing by feeling energy dancing through your body.
27. Mental power posture, mentally picturing oneself smiling and successful, connecting with confident, successful feelings and then honestly projecting them often brings on genuine confident, successful feelings.

The method includes re-creating challenging real life situations to allow participants to practice skills in these particular circumstances.

The method includes detailed discussion of habits, how to successfully change habits and the four stages of conscious change.
28. Habits are often automatic, subconscious, unintended and acquired from experience and environment without conscious intent.
29. Habits are hard to change because they are automatic and subconscious, people are often not consciously aware of intending to do the actions so they may not be aware of when habits are directing their behavior.
30. The secret to successfully changing habits is to make unconscious actions conscious and to consciously cultivate desirable new habits to replace undesirable old bad habits and to always coach in positive terms.
31. Habit change is related to the four steps of conscious change: unconscious incompetence, conscious incompetence, conscious competence and unconscious competence.
32. Criticism, self castigation, focusing on mistakes and what is wrong reinforces errors and detracts from successful skill building processes.

The method also includes exercises and demonstrations that illustrate concepts that support effective speech.
33. Stutterers can often sing. Singing words slightly, relaxing and listening to the rhythm and beat of speech helps stutterers to overcome stuttering.
34. Talking with intentionally tight tummy muscles to demonstrate a source of stressed, strained speech.
35. Voices affect listeners' feelings exercises.
36. Summoning up a positive spirit and honestly projecting it raises and enhances one's own positive mood as well.

While the above description contains many specific techniques and methods, these should not be construed as limitations on the scope of the invention, but as exemplifications of the presently preferred embodiments thereof. Many other ramifications and variations are possible within the teachings of the invention.

For example, the invention's teaching method can be expanded, customized and adapted for specific industry needs such as accounting, healthcare or elementary education.

The invention's teaching method can be adapted to teach attractive, articulate speech skills for languages other than English.

Thus the scope of the invention should be determined by the appended claims and their legal equivalents, and not by the examples given.

I claim a teaching method comprising of:

1. Speaking with a beat, punching each word and syllable spoken slightly, speaking with a slight staccato to add clarity and emphasis to spoken words;

2. Power vowels, extending vowel sounds to add emotion and emphasis to speech;

3. Punctuating and phrasing with deliberate, powerful pauses;

4. Inserting slight slivers of silence between words and similar sounding syllables to add clarity to speech;

5. Speaking in polished phrasing of no more than eight to ten beats or syllables per phrase;

6. Practicing with poetry or by speaking a song out loud;

7. Listening to the rhythm and beat of speech as it is spoken to command the rhythm, beat, phrasing and melodic flow of spoken words;

8. Getting going with a giggle to consciously connect with pelvic diaphragm muscles, using dual diaphragm drive to powerfully project spoken words and sounds;

9. Kicking consonants, adding extra energy and emphasis to consonant sounds to clarify speech;

10. Yodeling while yawning to relax tight, tense throat muscles;

11. Consciously targeting the specific tone speakers choose to-project with their speech;

12. Focusing on the feelings speakers want to project through their speech rather than worrying about what specific words are correct to express their thoughts;

13. Singing slightly as we speak to summarize many of these individual skills into a higher order summary skill;

14. Practicing vocal skills by reading to children and then working to retain the same feeling of fun and fantasy in all business and personal speech;

15. Breaking wave breathing techniques which engage lower abdominal muscles to power deep relaxation and belly breathing;

16. Using breathing as a barometer of body bearing and balance;

17. Clenching a raised fist illustrates how tension is transmitted throughout the body, how tension tires muscles, inhibits breathing and makes people feel anxious;

18. Tightening tummy muscle to illustrate the effects of lower abdominal tension on breathing, speech, relaxation and overall sense of well-being;

19. Clenching and tensing exercises show how tension is unconsciously used to raise levels of mental attention with tiring and dangerous long term effects;

20. Slumping versus confident body bearing exercise shows how body bearing and posture affect feelings and prompt mental perspectives people unconsciously adopt;

21. Consciously pulling energy inwards in a fearful clench, tense defensive posture affects people's feelings differently from consciously and confidently radiating energy outwards;

22. Visualizing yourself at your best with best self exercises allows people to consistently connect with their optimal physical and emotional energy states;

23. Feeling energy dancing throughout the body as in response to music illustrates how people can energize and raise attention levels without stressful clenching and tensing;

24. Visualizing ourselves smiling and successful through mental power posture exercises allows people to consistently connect with their optimal way of being and feeling;

25. Exercises illustrate how habits are automatic, unconscious and frequently acquired unconsciously, this makes them resistant to change, but making habits conscious and consciously substituting positive new actions in the place of old bad habits quickly and easily affects change;

26. Severe self scolding, self criticism and/or self condemnation reinforces mistakes and bad behaviors people are trying to eliminate;

27. Tone of voice is meaning, vocal tone is usually far more important than words spoken;

28. Tone of voice affects listeners feelings and those feelings determine and prompt listeners' actions;

29. By seeing ourselves with an emotion, feeling that emotion and honestly projecting it, we can genuinely take on any feelings we consciously choose to project;

30. Coaching ourselves and others in positive terms and describing what we are trying to achieve and why provides clear, positive images of goals and the benefits of attaining them.
